(19) United States
(12) Patent Application Publication
(10) Pub. No.: US 2021/0122186 A1
(43) Pub. Date: Apr. 29, 2021

(54) DECORATIVE WOOD MOSAIC AND METHOD OF MAKING SAME

(71) Applicant: J and H Forest Farm LLC, Grand Rapids, MI (US)

(72) Inventor: Amy M. Horton, Grand Rapids, MI (US)

(21) Appl. No.: 16/663,495

(22) Filed: Oct. 25, 2019

(51) Int. Cl. B44C 3/12; B44C 5/04; B44C 1/28

(52) U.S. Cl. CPC B44C 3/123; B44C 1/28; B44C 5/043

(57) ABSTRACT

A decorative wood mosaic or assembly includes a rigid support member selectively formed to have a preselected shape that is coated with one or more decorative coatings. Individual pieces of end-grain cut wood rounds of discretionary shapes and sizes are secured to the rigid support member and selectively coated with one or more decorative coatings to create a three-dimensional work of art.

### FIELD OF THE INVENTION

The present invention relates in general to decorative articles and, more particularly, to decorative articles comprised of plurality of wood pieces assembled on a substrate to create a decorative assembly.

### BACKGROUND OF THE INVENTION

Decorative designs and patterns are often displayed on walls of homes, offices, or other structures to enhance their decor. The surface appearance of wood is a combination of the growth-ring structure or grain, the orientation of the surface that results from cutting, and particular anatomical features of the wood. The term “end-grain” is used to refer to distinctive markings on lateral or cross-sectional surfaces of wood, i.e. the grain of wood seen when a piece of wood is not cut along the length of its trunk but when it is cut across the growth rings.

### SUMMARY OF THE INVENTION

The present invention provides for a method to form a decorative article composed of a substrate specifically cut to depict an image and plurality of end-grain cut wood pieces of various dimensions attached thereto, which gives the visual impression of a three-dimensional work of art. Additionally, the present invention provides a discretionary mosaic art kit through which the user can create a work of art which may be viewed as an art object having limitless potential for combined design shapes and color patterns.

In one form of the present invention, a method of forming a decorative wood mosaic includes providing a template of a predetermined decorative design, tracing an outline of the decorative design on a substrate, cutting the outline out of the substrate to form a rigid support member, end-grain cutting a plurality of wood pieces to form a plurality of wood rounds with each wood round having a first and a second flat surface defined by a circumference of each respective wood round. The wood rounds include varying diameters and thicknesses, and the circumference of each wood round includes bark. The next step is to select wood rounds to be used for the decorative wood mosaic and apply a decorative coating wash to the first flat surface of the selected wood rounds. Next is to apply a decorative coating to a first side of the rigid support member followed by applying an adhesive material to the second flat surface of the selected wood rounds. The last step is to place the second flat surface of the selected wood rounds at respective selected positions on the first side of the rigid support member.

According to one aspect, the decorative coating is an acrylic-based coating.

According to another aspect, the decorative coating wash is obtained by mixing three parts of water with one part of the decorative coating.

According to yet another aspect, the method further includes applying another coating over the decorative coating wash and the decorative coating.

In another form of the present invention, a decorative wood mosaic includes a rigid support member forming a backing for a predetermined decorative design with at least one side of the rigid support member including one or more markings thereon, and a plurality of end-grain cut wood rounds with each cut wood round having a first and a second flat surface defined by a circumference of each respective wood round. The wood rounds include varying diameters and thicknesses, and the circumference includes bark. The plurality of end-grain cut wood rounds assembled on the rigid support member to effect the predetermined decorative design by providing one or more decorative coatings to be applied on the at least one side of the rigid support member, providing one or more decorative coating washes to be applied to the first flat surface of selected wood rounds, applying an adhesive material to the second flat surface of the selected wood rounds, and placing the second flat surface of the selected wood rounds at respective selected positions on the at least one side of the rigid support member.

According to one aspect, the decorative coating is an acrylic-based coating.

According to another aspect, the decorative coating wash is obtained by mixing three parts of water with one part of the decorative coating.

According to yet another aspect, the decorative wood mosaic further includes another coating applied over the decorative coating wash and the decorative coating.

Thus, the decorative wood mosaic includes a rigid support member selectively formed as an image, coated with one or more decorative coatings, and arranged to accommodate individual pieces of end-grain cut wood rounds of discretionary shapes and sizes and selectively coated with one or more decorative coating washes to be discretionary attached to the rigid support member to create a three-dimensional work of art.

These and other objects, advantages, purposes and features of the present invention will become apparent upon review of the following specification in conjunction with the drawings.

### BRIEF DESCRIPTION OF THE DRAWINGS

The drawings are not necessarily to scale and in some instances proportions have been exaggerated in order to more clearly depict certain features of the invention.

FIG. 1 is a perspective view of a decorative assembly wood mosaic in accordance with an embodiment of the present invention;

FIG. 1A is a close-up view of a portion of the decorative wood mosaic illustrated in FIG. 1;

FIG. 2 is a perspective view of a template or pattern of a decorative design used in the formation of the rigid substrate for the decorative wood mosaic illustrated in FIG. 2;

FIG. 3 is a perspective view of a substrate material from which a rigid substrate cut-out of the decorative design is made using the template of FIG. 2;

FIG. 4 is a perspective view of the rigid support member illustrated in FIG. 3, shown with one side of the rigid support member painted in two different colors;

FIG. 5 is a perspective view of the rigid support member illustrated in FIG. 4, shown with selected wood rounds affixed thereto in accordance with the present invention;

FIG. 6 is a side elevation view of a portion of the decorative wood mosaic illustrated in FIG. 1; and

FIG. 7 are top views of various alternative rigid support members that have been cut out into selected design patterns for use in creating alternative decorative assembly wood mosaics in accordance with the present invention.

### DETAILED DESCRIPTION OF PREFERRED EMBODIMENTS

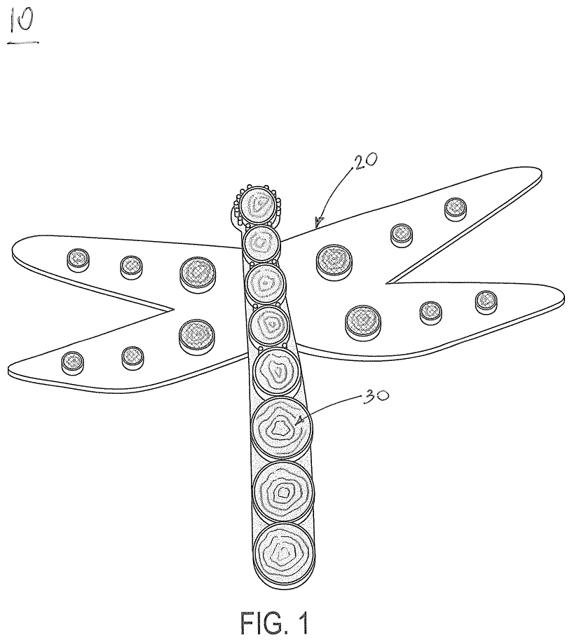

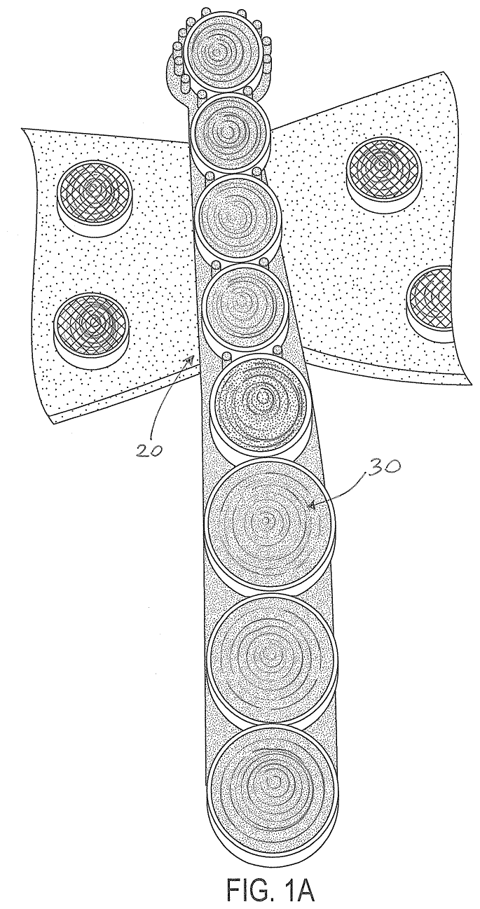

In the description which follows, like parts are marked throughout the specification and drawings, respectively. Referring now to the drawings and the illustrative embodiments depicted therein, a decorative wood mosaic or assembly 10 having a predetermined design of a three-dimensional dragon fly of the present invention is illustrated in FIG. 1. The design is achieved by assembling a plurality of pre-cut wood pieces on a pre-cut substrate based on a selected pattern to achieve the desired design, as will be described in greater detail hereinafter. The decorative wood mosaic 10 includes a rigid support member 20 and a plurality of end-grain cut wood rounds 30, such as shown in FIGS. 1 and 1A. In accordance with the present invention, and as discussed in more detail below, the wood rounds 30 comprise laterally cut tree portions, such as from trunks, stems, branches, or twigs of a tree. The wood rounds 30 may thus be formed from re-purposed wood from a tree that has had to have been cut down, such as for another reason.

In the illustrated embodiment, the rigid support member, or backing, or backer, or rigid support 20 is pre-cut in a desired or selected pattern, which in the illustrated embodiment appears as a dragon fly, with one side of the rigid support member 20 being color coated. However, it is contemplated that the rigid support member 20 may be pre-cut into a limitless number of various patterns, including but not limited to a butterfly, wolf, sun, moon, cloud, tree, star, a shape, a person's name, a message, words, letters, symbols, and the like. Additionally, the shapes and sizes of each particular pattern are discretionary based on the user's artistic preferences.

The choice of colors, style, and patterns of coloring the rigid support member 20 is purely discretionary based on the user's artistic preferences. In an exemplary embodiment, the dragon fly, the image of which serves as the rigid support member 20, has a body colored in one color and a pair of wings colored in another color, with style and patterns of coloring also differing between the body and the wings. It is envisioned that an acrylic-based paint or coating is used to color the rigid support member 20. It is further contemplated that the choice of material used as the rigid support member 20 depends on whether the decorative wood mosaic 10 is intended for indoor or outdoor applications, as well as personal preferences of the user. For example, a foam core board may be more suitable for indoor applications, while a piece of wood, plastic, or bark may be preferential to one ordinary skilled in the art for outdoor use.

The plurality of end-grain cut wood rounds, or wood slices, or tree slices 30 are natural wood pieces that have been pre-cut from portions of a tree, such as trunks, stems, branches, or twigs of a tree to resemble slices, disks, or generally cylindrical, miniature tree stumps having in the illustrated embodiment a top and bottom generally horizontal flat surfaces. The wood rounds 30 are cut from or out of a wood tree portion, such as laterally or approximately at 90 degrees across the growth rings of the tree portion, i.e. not along the length of the tree portion. This type of cut exposes the character of the wood rings and graining. End-grain cuts produce highly-aesthetic wood with character and color. Preferably, the wood rounds 30 are cut with bark remaining on their circumference. However, bark may either be partially or completely removed from at least some of the wood rounds 30 to accommodate the user's artistic preferences, and/or the wood rounds may be cut at slight angles to the wood grain. The type of wood used to cut the wood rounds varies based on availability and user's preferences and including but not limited to pine, maple, birch, poplar, oak, and etc. The cross sections of wood rounds 30 are mostly circular but may be any shape due to the variances of shapes in stems found in nature. In accordance with the present invention the term naturally shaped refers to the shape of a tree portion that is cut across the grain, such as for example laterally or angularly, whereby the outer circumference of the naturally shaped wood round is then defined by the shape of the tree portion as it naturally grew in nature along with the cut to the tree portion.

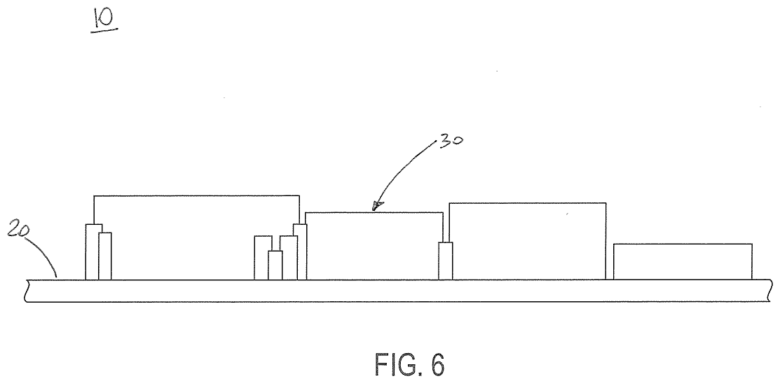

In the illustrated embodiment shown in FIG. 6, the wood rounds 30 are all different in thickness, with the average thickness being 0.5 inches, but decorative wood assemblies in accordance with the present invention may be constructed with different average thicknesses or even have substantially the same thicknesses. The difference in thickness of the wood rounds 30 provides for a desired three-dimensional impression of the decorative wood mosaic 10 when the wood rounds 30 are assembled and/or attached to the rigid support member 20. The diameter of the wood rounds 30 also varies from 1/32 of an inch to over 5 inches depending on the size of the wood used. However, the shapes, thicknesses and diameters of the wood rounds 30 are discretionary based on the user's preferences. In the preferred embodiment, best shown in FIG. 1A, the top and bottom flat surfaces of the wood rounds 30 are not sanded or polished in order to provide a more of a rustic impression to the decorative wood mosaic 10. However, it is also envisioned that the surfaces of the wood rounds 30 may be sanded or polished to achieve a smooth look and/or safe-to-touch feel.

As shown in FIG. 1, the wood rounds 30 may be selectively color coated. The choice of colors, style, or patterns of coloring and surfaces of the wood rounds 30 to which coloring is applied are purely discretionary based on the user's artistic preferences. In the preferred embodiment, however, only the top flat surface of the wood rounds 30 is coated or painted. Further, it is preferable that a decorative coating wash, paint wash, or color wash is used to paint the top flat surface of the wood rounds 30. The use of the color wash is preferred because once the end-grain cut surface of a wood round absorbs the coating, the wash will add color without sacrificing the visual interest of the wood's grain and texture, thereby producing highly-aesthetic colored wood with character. The paint wash may be prepared by diluting one part of acrylic-based paint with three parts of water. Alternatively, other concentrations of paint in the paint wash solution may also be used.

Once at least some of the wood rounds 30 are color coated, the wood rounds 30 are secured to the rigid support member 20 by securing means, such as by an adhesive, glue, suction, interlocking, or any other fixing means. The placement or the manner in which the wood rounds 30 are assembled on the rigid support member 20 is discretionary based on the user's artistic preferences. Alternatively, the rigid support member may have one or more markings or add-ons either to indicate preferred placement and/or size of a wood round on the rigid support member 20, or to further enhance the decorative wood mosaic 10.

Optionally, the rigid support member 20 may further include one or more holes, hooks or other means attached to it to facilitate hanging of the art work on a wall. This includes, for example, mounting hooks or holes in a backside of the rigid substrate 20. Alternatively wire, twine, string or the like may be affixed to the decorative wood assembly, such as to hang on a wall or from the ceiling or the like.

A method of creating a decorative wood mosaic 10 will now be discussed with reference to the drawings. The first step of the method is to collect various types and lengths of wood. The type of wood includes but not limited to pine, maple, birch, or poplar. The lengths of wood pieces can be anywhere from 6 inches in length for the smallest size of wood pieces to over four foot in length for the thicker lengths of wood pieces. Depending on the size of the wood pieces, a table saw, band saw, or pruning shears are used to cut cross sections of the wood, or wood rounds 30, which are mostly circular in nature but can be any shape due to the variances found in nature. The wood rounds 30 are all different in thickness, with the average thickness being ½ inch. The diameter of each wood round 30 also varies from 1/32 of an inch to over 5 inches depending on the size of the wood used. The bark around the wood rounds may be partially, entirely, or not at all removed. After cutting the wood rounds they are placed in a tote for later use.

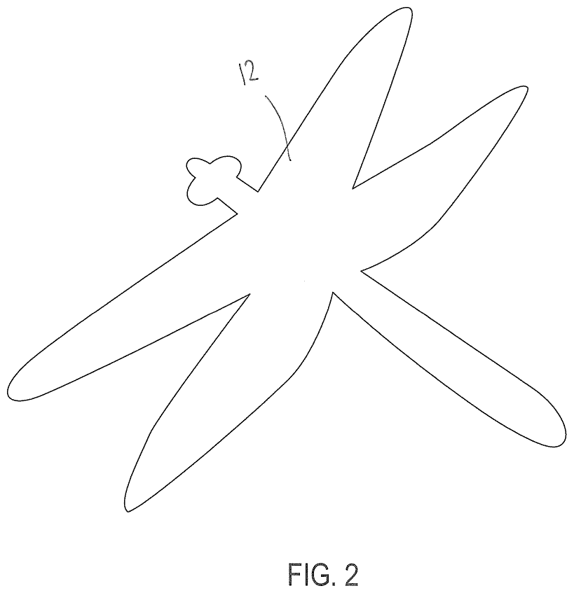

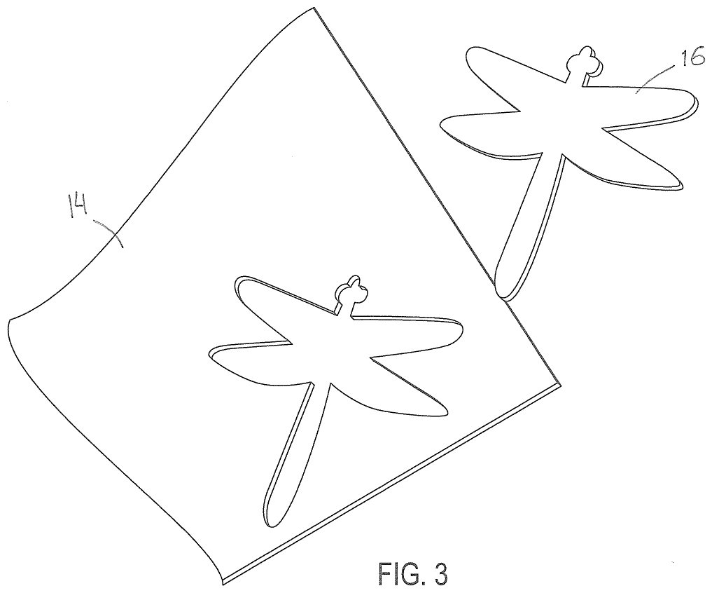

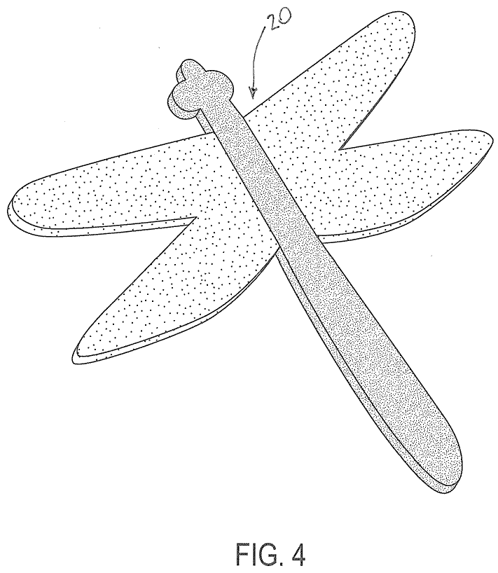

The following step involves preparation of a rigid support member 20 for the decorative wood mosaic 10. As shown in FIG. 2, a template 12 is first prepared by drawing or outlining a desired pattern or image on a paper, cardboard, or the like, and then cutting the desired pattern out of the paper. As shown in FIG. 2, an exemplary desired pattern is a dragon fly. The template 12 is then placed onto a rigid substrate 14, traced to form an outline of the desired image, and then the desired image is cut out of the rigid substrate 14, using a utility knife, scroll saw, or router, depending on the hardness of the substrate 14, to form a rigid backer 16, as shown in FIG. 3. The material used for the substrate 14 may be foam core board, wood, or plastic depending on an intended application. The rigid backer 16 is then painted with an acrylic-based paint to create a colored rigid support member 20, as shown in FIG. 4. The colored support member 20 is then set aside and allowed to dry. It should also be appreciated that the coloring of the rigid backer 16 may also be accomplished by means other than paint, such as for example, pencils, crayons, markers, and etc. Additionally, it should be appreciated that the use of the template 12 described above is not necessary, as the desired pattern may be cut out of the substrate 14 by freehand, or already pre-formed.

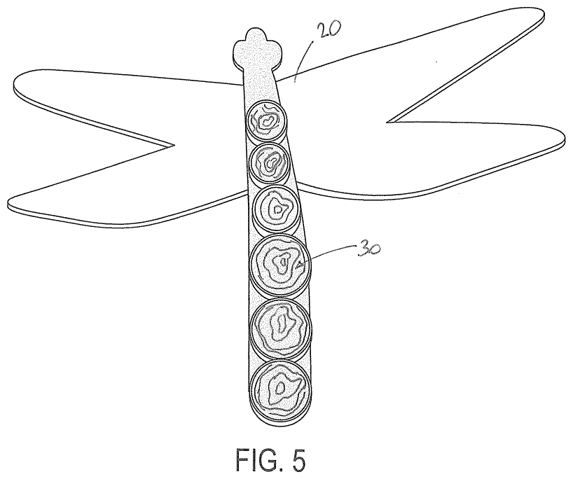

The wood rounds 30, which were stored in the tote, are now selected based on the user's preference and painted with a color wash by using a brush to create painted wood rounds 30. The color wash is made by taking a 2 oz bottle of acrylic-based paint and pouring the paint into an 8 oz jar. Then 6 oz of water is added to the jar to make a paint/water solution. The solution is then mixed or the paint brush is used to mix the paint/water solution. Selected painted wood rounds 30 are then affixed, for example as shown in FIG. 5, to the colored rigid support member 20 based on the user's artistic preference.

In accordance with another aspect of the present invention, a kit for creating a decorative wood assembly 10 may be provided, such as in a package sold online or through retail or other craft stores, in which a purchaser or user is able to create the decorative wood assembly 10, such as for example the assembly 10 illustrated in FIG. 1. The kit may include all of the materials necessary to create the assembly 10, including for example, a full supply of various size wood rounds 30 prepared as described above, a rigid substrate 20, as well as assorted and pre-mixed paints of various colors, a paint brush, a supply of glue, and an instructions sheet suggesting at least one way for creating the decorative wood mosaic 10. In a particular embodiment of the kit, the substrate 20 may be provided with pre-marked or pre-painted markings to provide reference points for assembly of the wood rounds 30 onto the backer 20. Still further, a kit may be provided that includes a pattern, such as on a sheet of paper or plastic, that may be used as a template to trace out the pattern onto a user or purchaser supplied rigid substrate material, such as foam board, for cutting the substrate 20 with the selected pattern.

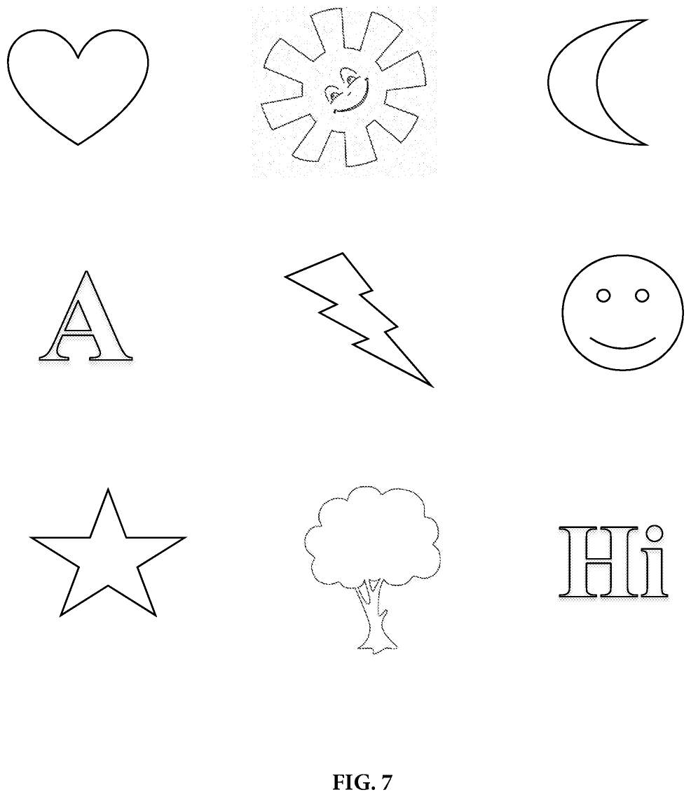

With reference to FIG. 7, it should be appreciated that, as noted above, numerous alternative variations of rigid substrates may be formed and used to create alternative design assemblies in accordance with the present invention. This includes, for example as shown in FIG. 7, a heart, sun, moon, letter, lightning, smiley face, star, tree, and message. It should be appreciated that these alternatively configured rigid substrates may be formed using correspondingly alternatively designed templates, such as from paper, cardboard, or the like. Still further, decorative design assembly wood mosaics in accordance with the present invention may be constructed without using a template, where the rigid substrate design is cut from a base substrate material by freehand, or the rigid substrate design is directly formed, such as by a press or the like.

Therefore, the decorative wood mosaic of the present invention provides for a fun and easy to use mosaic through which the user can create at his or her discretion a work of art, which has a limitless potential for creative designs and color patterns. While wood rounds formed from natural, tree portions without further processing are discussed above in connection with the preferred embodiment, it should be appreciated that alternative wood rounds may be used in accordance with the present invention, such as wood rounds formed from processed wood, such as wooden dowels, rods, or the like. Other changes and modifications in the specifically described embodiments may be carried out without departing from the principles of the present invention, which is intended to be limited only by the scope of the appended claims, as interpreted according to the principles of patent law including the doctrine of equivalents.

1. A decorative wood assembly, said decorative wood assembly comprising:
a rigid support member formed in a preselected pattern and having a front side and a back side; and
a plurality of wood rounds selectively secured to the front side of the rigid support member.

2. The decorative wood assembly of claim 1, wherein said rigid support member is formed from a foam board material.

3. The decorative wood assembly of claim 1, wherein said wood rounds comprise tree portions that are cross-cut relative to the grain of the tree portions.

4. The decorative wood assembly of claim 3, wherein said wood rounds are naturally shaped.

5. The decorative wood assembly of claim 4, wherein at least some of said plurality of wood rounds include bark on the outer circumference.

6. The decorative wood assembly of claim 1, wherein said wood rounds have varying thicknesses.

7. The decorative wood assembly of claim 1, wherein said wood rounds have varying diameters.

8. A method of forming a decorative wood mosaic comprising:
providing a template of a predetermined decorative design;
tracing an outline of the decorative design on a substrate;
cutting the outline out of the substrate to form a rigid support member;
end-grain cutting a plurality of wood pieces to form a plurality of wood rounds, each having a first and a second flat surface defined by a circumference of each respective wood round, wherein the wood rounds comprise varying diameters and thicknesses, and wherein the circumference includes bark;
applying a decorative coating wash to the first flat surface of selected wood rounds;
applying a decorative coating to a first side of the rigid support member;
applying an adhesive material to the second flat surface of the selected wood rounds; and
placing the second flat surface of the selected wood rounds at respective selected positions on the first side of the rigid support member.

9. The method of claim 8, wherein the decorative coating is an acrylic-based coating.

10. The method of claim 9, wherein the decorative coating wash is obtained by mixing three parts of water with one part of the decorative coating.

11. The method of claim 8 further comprising applying another coating over the decorative coating wash and the decorative coating.

12. A decorative wood mosaic comprising:
a rigid support member forming a backing for a predetermined decorative design with at least one side of said rigid support member including one or more markings thereon; and
a plurality of end-grain cut wood rounds, each having a first and a second flat surface defined by a circumference of each respective wood round, wherein said wood rounds comprise varying diameters and thicknesses, and wherein the circumference includes bark, said plurality of end-grain cut wood rounds assembled on said rigid support member to effect the predetermined decorative design by the following steps:
providing one or more decorative coatings to be applied on the at least one side of said rigid support member;
providing one or more decorative coating washes to be applied to the first flat surface of selected wood rounds;
applying an adhesive material to the second flat surface of said selected wood rounds; and
placing the second flat surface of said selected wood rounds at respective selected positions on the at least one side of said rigid support member.

13. The decorative wood mosaic of claim 12, wherein said one or more decorative coatings are an acrylic-based coating.

14. The decorative wood mosaic of claim 13, wherein said decorative coating wash is obtained by mixing three parts of water with one part of said one or more decorative coatings.

15. The decorative wood mosaic of claim 12 further comprising another coating applied over said one or more decorative coating washes and said one or more decorative coatings.
